(19) United States
(12) Patent Application Publication
(10) Pub. No.: US 2010/0320658 A1
(43) Pub. Date: Dec. 23, 2010

(54) Apparatus for changing a leaf spring characteristic

(75) Inventors: Andreas MUELLER, Berlin (DE); Harold Schana, Johannesburg (ZA)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignees: Andreas Mueller, Berlin (DE); Harold Schana, Johannesburg (ZA)

(21) Appl. No.: 12/765,348

(22) Filed: Apr. 22, 2010

(30) Foreign Application Priority Data
Apr. 24, 2009 (DE) 10 2009 002 635.5
May 11, 2009 (DE) 10 2009 003 008.5

(51) Int. Cl. F16F 3/00

(52) U.S. Cl. 267/151

(57) ABSTRACT

The invention relates to an apparatus for changing a spring characteristic, which includes at least one tension and/or compression spring for changing the spring rate of a leaf spring to which the apparatus can be connected, wherein a mounting device for mounting the tension and/or compression spring on the leaf spring is connected to a first end of the tension and/or compression spring.

It is provided that the apparatus (3) furthermore includes at least one spiral spring (200) for additionally controlling the leaf spring rate and an attachment device (220) for mechanical attachment of the spiral spring (200) to the leaf spring (10) and variable adjustment of the spacing (212) between at least one spiral spring section (214) and the leaf spring (10), wherein the spiral spring (200) is mechanically connected to the second end of the tension and/or compression spring (100).

The invention also relates to a spring assembly, which includes at least one leaf spring (10) and an attached apparatus (3) according to the invention for changing a leaf spring characteristic, as well as a motor vehicle, in particular a van or a bus, which includes at least one spring assembly according to the invention.

The present invention relates to an apparatus for changing a leaf spring characteristic of a leaf spring used primarily in automobiles, such as vans or buses. The present invention also relates to a spring assembly which includes the apparatus of the invention for changing a leaf spring characteristic and a leaf spring. The present invention is also directed to an automobile which includes the spring system according to the invention.

The use of the aforementioned leaf spring chassis suspensions in automobiles is known in the art. These leaf spring chassis suspensions are inexpensive, undemanding, and almost maintenance-free. They are employed, for example, in vans, in particular camp mobiles and the like. The leaf spring chassis keep the tires of the rear axle securely in the travel lane and support the weight of the vehicle body.

When using leaf springs, their spring characteristic is designed for the maximum load capacity of the vehicle, although this frequently reduces the comfort level. If the vehicle travels with a load that is significantly less than the maximum load capacity, the leaf spring chassis suspensions have a stiff and very hard spring response. The vehicles with such spring chassis suspensions also tend to tilt sideways in turns and roll excessively when the driver counter-steers. Moreover, in extreme situations, for example at a full stop, vehicles provided with leaf spring chassis suspensions have a tendency to so-called axle torsion, meaning that torsion of the axle or of the chassis suspension is generated about an axis perpendicular to the direction of travel, normally the vehicle axis. This causes nonuniform torsional loading of the leaf spring packet. Associated therewith is the introduction of vibrations into the vehicle, which diminishes control. The associated undesirable deformation of the leaf spring is shown in FIG. 5. The arrow indicates the direction of the torsion moment acting on the axle, which is transmitted from the clamping brackets and the bearing block to the leaf spring. This results in an undesirable low spring deflection on the right side and a torsional load on the left side, for which the spring is not designed.

EP 0 633 307 A1 discloses an adjustable coil spring arrangement for the purpose of adjusting a leaf spring characteristic, whereby an additional coil spring is arranged as a tension spring on one side of a leaf spring. Disadvantageously, this embodiment exhibits relatively severe wear at the location of the attachment of the coil spring to the leaf spring, as well as an inability to directly affect the bending line of the leaf spring.

It is an object of the invention to provide an apparatus and a spring assembly of the aforedescribed generic type, which is able to significantly improve the spring characteristic of leaf spring chassis suspensions, in particular in extreme driving situations.

The aforementioned object is solved by an apparatus for changing a leaf spring characteristic, wherein the apparatus has at least one tension and/or compression spring for changing the spring rate of a leaf spring to which the apparatus can be attached, wherein a mounting device for mounting the tension and/or compression spring on the leaf spring is connected to a first end of the tension and/or compression spring. According to the invention, the apparatus also includes at least one spiral spring for additionally affecting the leaf spring rate and an attachment device for mechanically connecting the spiral spring to the leaf spring and for variably adjusting the spacing between at least one spiral spring section and the leaf spring.

To produce an assembly consisting of the tension and/or compression spring and the spiral spring, the spiral spring may be mechanically connected with the second end of the tension and/or compression spring.

The spiral spring is hence an extra or additional spring, which is not part of the original leaf spring packet. Optionally, instead of an additional spiral spring, several superimposed spring layers may be used which in conjunction form a packet, similar to the leaf spring packet. One of the end regions of the spiral spring should be mechanically connectable to the leaf spring in spaced-apart relationship by way of the attachment device. The attachment device as well as the spiral spring should be constructed such that the spacing between the spiral spring and the leaf spring can be adjusted with the attachment device. Accordingly, the pretension in the spiral spring and therefore also the spring rate of the leaf spring connected to the spiral spring can be adjusted by adjusting the spacing between the leaf spring and the end region of the spiral spring. Advantageously, the spiral spring has a curvature which is different from the surface curvature of the uppermost layer, or the main leaf, of the leaf spring. As a result, the spacing produced by the curvature can be varied with the attachment device. To control each side of a leaf spring which is symmetrically arranged on a bearing block, the tension and/or compression spring operates on a first leaf spring side, while the spiral spring operates on the second leaf spring side.

Accordingly, the apparatus of the invention allows two separate adjustments of the leaf spring characteristic for each leaf spring, namely on one hand adjustment of the tension and/or compression spring and on the other hand adjustment of the spiral spring. As a result, a total of four possibilities for adjustment are provided on each axle equipped with two leaf spring packets. As a result of the twofold control on the spring rate of a leaf spring, the driving performance of a vehicle equipped with a leaf spring can be adjusted with significantly greater differentiation, in particular when braking or accelerating or with uneven vehicle loading. In other words, the combination of the two spring elements of the apparatus of the invention with variable spring force can provide possibilities for adjustment which cannot be implemented by using only a single spring.

The tension and/or compression spring may be mechanically connected directly to the spiral spring. This direct connection can be implemented with a screw connection. In this preferred alternative, the spiral spring and the tension and/or compression spring should be connected on the side of the tension and/or compression spring facing the mounting device. This preferred embodiment therefore represents an alternative to the embodiment where the tension and/or compression spring is connected to a leaf spring on one side of the leaf spring, whereas a spiral spring is connected to the leaf spring on the other side of the leaf spring, whereby the tension and/or compression spring and the spiral spring are only indirectly connected with one another by way of the leaf spring.

For affixing the spiral spring to the leaf spring, the leaf spring has at least one surface that is substantially perpendicular to the bending plane and configured to make contact over an area with and be attached to a partial region of an upper layer of the leaf spring to be controlled. The spiral spring can be affixed by conventional clamping, which is already employed, for example, in the manufacture of the leaf spring packet. The term “bending plane” designates a plane in which the bending occurs. This is essentially the plane of the effective forces. The term “upper layer” of the leaf spring designates the main leaf of the leaf spring.

Advantageously, the spiral spring may have a radius of curvature which is different from the radius of curvature of the uppermost layer of a leaf spring to which the spiral spring layer is to be attached. The curvature of the spiral spring is hence also located in the bending plane and operates to increase the geometrical moment of inertia of the combination of leaf spring and spiral spring and concurrently increases the bending stiffness. The greater the spacing between the spiral spring and the leaf spring, the higher is the bending stiffness and therefore also the spring rate. However, the spring rate of the leaf spring is not only affected by the design, but also by the pretension of the spiral spring to be connected to the leaf spring, wherein the spiral spring in conjunction with the individual layers of the leaf spring operates like a spring packet. The spacing in the spiral spring end region is therefore mainly a result of the curvature of the spiral spring. As mentioned above, the spacing of the spiral spring end in relation to the leaf spring setting and therefore the pretension of the spiral spring can be adjusted with the attachment device.

For varying the spring force exerted by the tension and/or compression spring, the mounting device may have a first adjustment device for varying the pretension of the tension and/or compression spring.

In particular, the mounting device may include a clamping unit with at least one shaped receiving element for receiving a first threaded rod arranged on the tension and/or compression spring. The clamping unit allows clamping of the mounting device at essentially any location on an upper layer or the main leaf of the leaf spring. Advantageously, the clamping unit may include two clamping plates which may be connected with one another by threaded bolts and nuts, so that the distance between the clamping plates is reduced when the nuts are tightened, thereby producing a non-positive connection between the upper layer of the leaf spring and the clamping plates for affixing the mounting device. The length of the threaded rods of the clamping unit can be selected so as to encompass several layers of the leaf spring. The shaped receiving element is preferably arranged on an angle piece having one leg operating as clamping plate for producing the clamping effect, wherein the shaped receiving element may in particular be a through-hole through which a threaded rod extending from the tension and/or compression spring can be guided and screwed together behind the leg of the angle piece with one or several nuts. A tension force can be introduced into the threaded rod by turning the nut, thereby varying the pretension in the tension and/or compression spring connected to the threaded rod and hence affecting the spring rate of the leaf spring connected to the tension and/or compression spring.

In one particular embodiment, the nuts can also operate on a ball-ball socket unit which is supported on a leg of the angle piece to facilitate adjustment of different effective angles of the force applied by the tension and/or compression spring on the leg of the angle piece.

Advantageously, the tension and/or compression spring may have a spring rate of 30 to 80 N/mm. For application in most vans, springs with a spring rate of 40 to 55 N/mm, in particular 45 N/mm, has proven advantageous. It will be understood that the present invention is not limited to the aforedescribed spring rates, but can also be implemented with tension and/or compression springs having spring rates that deviate markedly from the listed values.

To provide adequate pretension, the spiral spring may be made from a typical leaf spring material.

As already described above, the spiral spring of a leaf spring is mechanically attached with an attachment device. The attachment device advantageously includes a bracket for encompassing at least one layer of the leaf spring. Advantageously, the legs of the bracket each have an external thread which, in cooperation with through-holes disposed on an additional clamping plate of the attachment device and the nuts, form a mechanical connection which is movable on the leaf spring and allows adjustment of the spacing between the leaf spring and the spiral spring, or the spiral spring end region, respectively. The ability to move the attachment device on the leaf spring advantageously facilitates installation of the apparatus of the invention. This means that the position of the bracket of the attachment device is not defined by a particular shaped element, but can be variably adjusted in a region regardless of the position at which the tension and/or compression spring is attached. The distance between the leaf spring and the spiral spring and region can be variably and continuously adjusted by turning the nuts arranged on the external threads of the legs of the bracket.

According to the invention, there is also provided a spring assembly which includes at least one leaf spring, optionally a leaf spring packet, and an attached apparatus according to the invention, wherein the spiral spring of the apparatus is not only affixed with the mounting device associated with the tension and/or compression spring and the attachment device associated with the spiral spring, but is also in contact with and attached to a partial region of the main leaf of the leaf spring over an area of at least one surface that extends essentially perpendicular to the bending plane.

Advantageously, the spiral spring is attached in the contact region with a clamping device to provide a force-transmitting connection of the individual layers of the leaf spring. The clamping device producing the initial leaf spring packet is also referred to as bearing block. This means that a conventional clamping device in form of one or more U-shaped brackets for producing a leaf spring packet can also be used to clamp the additional spiral spring, which is then arranged on the layers of the originally provided leaf spring as an additional leaf spring layer. If necessary, the original brackets may be replaced with somewhat longer brackets.

Advantageously, the contact region may be located essentially at the center of the leaf spring, and the connection between the leaf spring and the spiral spring may be realized with the attachment device, while the connection between the corresponding end regions of the leaf spring and the tension and/or compression spring may be realized with the mounting device. In other words, the spiral spring and the leaf spring are connected in the leaf spring region facing the mounting device. The mounting device and the attachment device are therefore arranged proximate to the lugs of the leaf spring, provided that the leaf spring is provided with lugs.

To attain optimal reinforcement or adjustment with the apparatus of the invention, the distance between the attachment device of a spiral spring and the mounting device on the tension and/or compression spring is at least five sixth of the length of the leaf spring. However, the invention is not limited to this length ratio, and shorter apparatuses may be arranged on longer leaf springs. To attain adequate changes in the leaf spring characteristic, spring elements with different spring rates and/or longer adjustment travel may optionally be employed.

Advantageously, the mounting device may be mechanically connected to the leaf spring by way of the clamping unit, whereas the attachment device may be mechanically connected to the leaf spring by way of the bracket. For connecting the leaf spring with the tension and/or compression spring, the spiral spring includes an angled region on the side facing the attachment device, wherein the angled region has a second through-hole through which a second threaded rod extending from the tension and/or compression spring is guided. The threaded rod can be secured in place using one or several nuts. As described before in relation to the first threaded rod, the screw connection can also operate on a ball-ball socket unit to compensate for different angles. The mechanical connection between the tension and/or compression spring with the first and/or second threaded rod may be implemented in a manner described in EP 0 663 307 A1.

The present invention also provides a motor vehicle, in particular a van or bus, which includes at least one spring assembly according to the invention. Advantageously, two spring assemblies may be arranged on each axle of such motor vehicle, or a separate spring assembly may be associated with each wheel.

With the present invention, a variable four-way adjustment is possible on a vehicle having a right leaf spring and a left leaf spring. Accordingly, the vehicle suspension can be optimized for motor vehicles having leaf springs by tightening the spring characteristic for a corresponding load. The normal driving performance is not diminished, but rather improved, in conjunction with the function of the original leaf spring of the motor vehicle, which is retained. The chassis suspension itself remains in its original state. Individual original parts need not be changed, with the exception of a possible lengthening of the clamping brackets for producing the leaf spring packet. The apparatus of the invention and the spring assembly produced with the apparatus of the invention advantageously provides a variably adjustable leaf spring reinforcement, or setting, such that depending on the type of the vehicle, the axle, and the leaf spring and leaf spring thickness, both the spring rate on the left side of the vehicle, on the right side of the vehicle, as well as in the travel direction in front of the vehicle axle and behind the vehicle axle, can be adjusted independent of one another.

In this way, the apparatus of the invention in cooperation with the installed conventional leaf spring can control the vibration properties and the spring properties of the vehicle body, particularly in extreme situations, so that the vehicle can either be returned to a stable road position or maintained in a stable road position. At the same time, aside from those extreme situations, the vehicle dynamics is optimized, whereby the dynamic behavior of the vehicle can be improved by using the apparatus of the invention, even if the vehicle is loaded to less than its maximum load capacity.

The present invention will now be described in more detail with reference to the appended drawings, which show in:

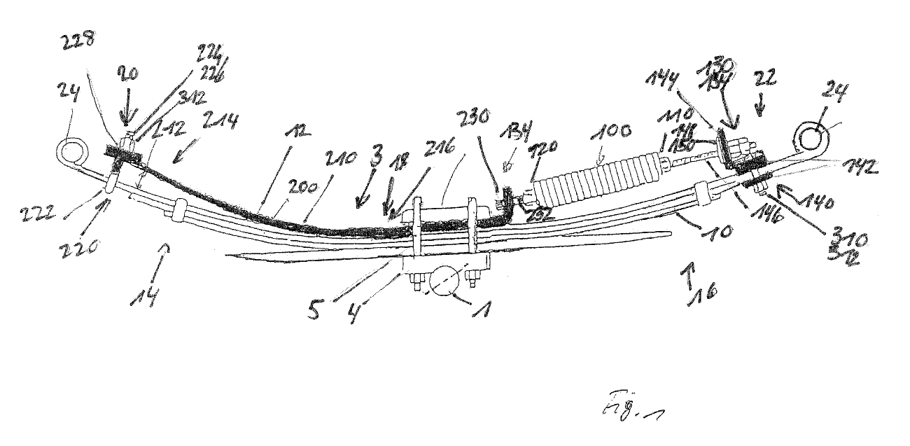

FIG. 1 an apparatus of the invention and a spring assembly in a side view;

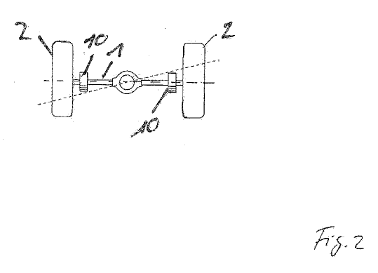

FIG. 2 an axle of the motor vehicle in the direction of travel;

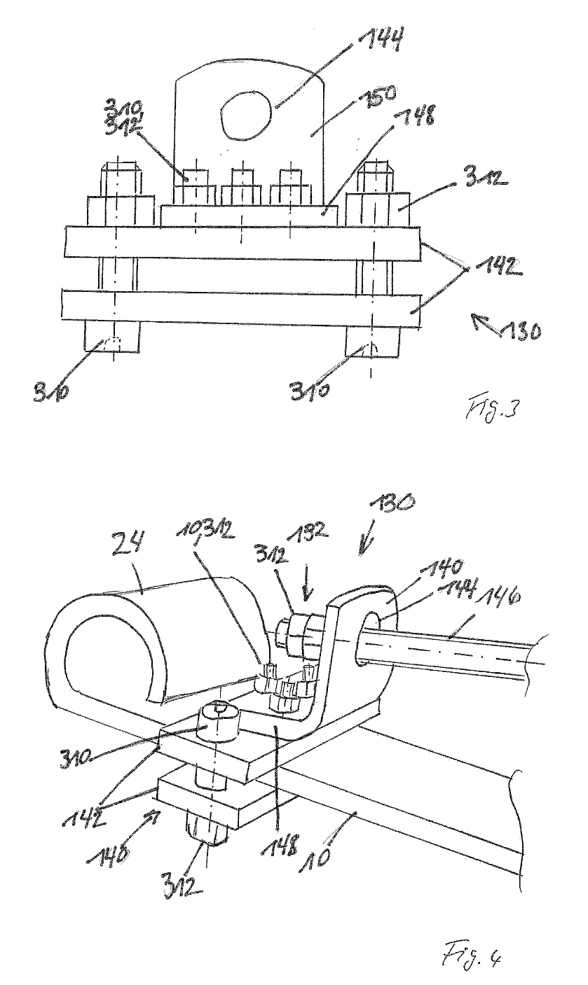

FIG. 3 a mounting device for mounting the tension and/or compression spring on the leaf spring in a side view;

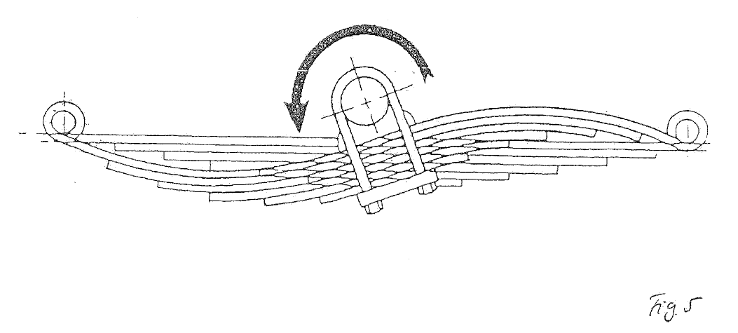

FIG. 4 a perspective diagram of the mounting device for mounting the tension and/or compression spring on the leaf spring; and

FIG. 5 a conventional leaf spring.

FIG. 1 illustrates a leaf spring 10 which connects several spring layers with one another to a packet. The apparatus 3 according to the invention is arranged above the leaf spring 10. The leaf spring 10 rests on an axle 1 and is connected to the axle 1 by way of a bearing block 4 having mounting brackets 5. The mounting brackets 5 encompass or clamp, respectively, also the spiral spring 200 of the apparatus 3 according to the invention. The tension and/or compression spring 100 is connected to the spiral spring 200 by way of a screw connection 230 and a second threaded rod 232. This tension and/or compression spring 100 is in turn connected to the first threaded rod 146 with a mounting device 130. This mounting device 130 includes a clamping unit 140 which is connected to the leaf spring 10.

On the opposite side, an attachment device 220 is arranged on the spiral spring 200 and engages with the leaf spring 10 by way of brackets 222. Two lugs 24 are arranged at the ends of the leaf spring 10 for attachment of the leaf spring 10 to the body of a motor vehicle. The invention is not limited to leaf springs 10 with lugs 24, meaning that springs with contact faces or support faces can also be used to support the vehicle body.

The leaf spring 10 includes at least a region of the surface curvature 12 where the leaf spring 10 is bent with a defined radius. Advantageously, this surface curvature 12 for creating the symmetry of the leaf spring 10 is provided on the first leaf spring side 14 as well as a second leaf spring side 16. The connection to the spiral spring 200 is therefore established in a first end region 20 of the leaf spring 10, while the connection to the tension and/or compression spring 100 is established in a second end region 22 of the leaf spring 10.

The spiral spring 200 makes contact across an area with a partial region of the main leaf 18 of the leaf spring 10. The spiral spring 200 has a curved region 210 which causes the spiral spring 200 to have a spacing 212 from the leaf spring 10 in the spiral spring end region 214. The spiral spring 200 is pressed by the aforementioned mounting bracket 5 over an area or a contact region 216, respectively, against the aforementioned partial region of the main leaf 18, where it is affixed. This means that the bearing block 4 in conjunction with the mounting brackets 5 and the layers of the leaf spring 10 securely clamps the spiral spring 200.

The attachment device 220 is constructed so as to be able to change the spacing 212. To this end, the brackets 222 encompassing the upper layer of the leaf spring 10 are each provided at the corresponding bracket legs 224 with an exterior thread 226, wherein the exterior threads 226 are guided through through-holes disposed in the attachment device 220 and affixed with nuts 312. By turning the nuts 312, the spacing can be changed and hence the pretension of the spiral spring 200 adjusted. Depending on the pretension of the spiral spring 200, a different force is applied to the leaf spring 10, so that the spring rate of the assembly consisting of leaf spring 10 and spiral spring 200 is different from that of the leaf spring 10.

The spring rate of the leaf spring 10 can be changed in a similar manner with the tension and/or compression spring 100, because the tension and/or compression spring 100 includes at its first end 110 a first threaded rod 146, which is guided through a shaped receiving element or through-hole 144 disposed in the leg 150 of an angle piece 148 and secured thereto with nuts 312. This angle piece 148, in conjunction with the first threaded rod 146 and the nuts 312, represents the first adjustment device 132 for the tension and/or compression spring 100. The angle piece 148 is connected by way of threaded bolts 310 and nuts 312 to a first clamping plate 142, which is in turn connected by way of threaded bolts 310 and nuts 312 to a second clamping plate 142. When the nuts 312 underneath the lower clamping plate of the clamping unit 140 are tightened, the lower clamping plate 142 is pulled against the upper clamping plate and therefore produces a clamping action with the leaf spring 10. As can be seen, the clamping unit 140 may be flexibly arranged in a defined longitudinal region of the leaf spring 10. The tension and/or compression spring 100 can be tensioned by operating the first adjustment device 132 at the end of the first threaded rod 146, thereby changing the force introduced into the leaf spring 10 by the tension and/or compression spring 100. Because the tension and/or compression spring 100 as well and the spiral spring 200 are essentially connected in parallel with the leaf spring, the spring rate of the overall assembly of the springs can be adjusted.

The spring force produced by the tension and/or compression spring 100 can not only be adjusted with the first adjustment device 132 on the first threaded rod 146, but also with a second adjustment device 134 implemented on a second threaded rod 232 by way of the screw connection 230 provided on the end of the leaf spring 200 facing the attachment device 220. The pretension of the tension and/or compression spring 100 can also be varied by rotating the screw connection 230.

The entire spring assembly is typically loaded by applying to the lugs 24 proportionally the weight of the vehicle body and by introducing the reaction force from wheel 2 into the axle 1. As can be seen, the curvature of the leaf spring 10 depends on the settings of the spiral spring 200 and of the tension and/or compression spring 100. Each leaf spring side 14 or 16 can be adjusted separately.

FIG. 2 shows the locations for placing of the spring assembly, or the apparatus 3, respectively, according to the invention at the positions of the leaf springs 10. As can be seen, a corresponding leaf spring 10 is associated with each wheel 2, so that two leaf springs and hence four adjustment possibilities according to the invention are provided on one axle 1.

FIGS. 3 and 4 show the mounting device 130 for mounting the tension and/or compression spring 100 on the leaf spring 10. Clearly visible are the clamping plates 142 which have a mutual spacing that can be varied with the bolts 310 and the nuts 312. In particular, the clamping plates 142 are able to clamp the upper layer or main leaf of a leaf spring 10 illustrated in FIG. 4. The mounting device 130 has an angle piece 148 adapted to receive the first threaded rod 146, wherein the shaped receiving element 144 implemented as a through-hole is arranged in the perpendicularly extending leg 150 of the angle piece 148. The angle piece 148 is hereby also connected to the upper clamping plate 142 with threaded bolts 310 and nuts 312.

### LIST OF REFERENCES SYMBOLS

1 Axle
2 Wheel
3 Apparatus
4 Bearing support
5 Mounting bracket
10 Leaf spring
12 Region of surface curvature
14 First leaf spring side
16 Second leaf spring side
18 Partial region of the main leaf
20 First end region of the leaf spring
22 Second end region of the leaf spring
24 Lug
100 Tension and/or compression spring
110 First end
120 Second end
130 Mounting device
132 First adjustment device
134 Second adjustment device
140 Damping unit
142 Clamping plates
144 Shaped receiving element, through-hole
146 First threaded rod
148 Angle piece
150 Leg of the angle piece
200 Spiral spring
210 Region of curvature
212 Spacing, spacing
214 Spiral spring section, spiral spring end region
216 Area, contact region
220 Attachment device
222 Bracket
224 Bracket leg
226 Exterior thread
228 Through-hole
230 Screw connection
232 Second threaded rod
310 Threaded bolt

1. Apparatus for changing a leaf spring characteristic, which includes at least one tension spring and/or compression spring for changing the spring rate of a leaf spring on which the apparatus can be installed, wherein a mounting device for attaching the tension and/or compression spring to the leaf spring is connected at a first end of the tension and/or compression spring,
wherein
the apparatus (3) furthermore comprises at least one spiral spring (200) for additionally controlling the leaf spring rate and an attachment device (220) for mechanical attachment of the spiral spring (200) to the leaf spring (10) and variable adjustment of the spacing (212) between at least one spiral spring section (214) and the leaf spring (10),
characterized in that
the spiral spring (200) is mechanically connected to the second end of the tension and/or compression spring (100).

2. Apparatus for changing a leaf spring characteristic according to at least one of the preceding claims,
characterized in that
the spiral spring (200) has at least one surface oriented essentially perpendicular to the bending plane, wherein the surface can be placed against and attached to a partial area of an upper layer of the leaf spring (10) to be controlled.

3. Apparatus for changing a leaf spring characteristic according to at least one of the preceding claims,
characterized in that
the spiral spring (200) has a radius of curvature which is different from the radius of curvature of an uppermost layer of the leaf spring (10) to which the spring layer is to be attached.

4. Apparatus for changing a leaf spring characteristic according to one of the preceding claims,
characterized in that
the mounting device (130) comprises a first adjustment device (132), with which the pretension of the tension and/or compression spring (100) can be varied.

5. Apparatus for changing a leaf spring characteristic according to one of the preceding claims,
characterized in that
the mounting device (130) has a clamping unit (140) with at least one shaped receiving element (144) for receiving a first threaded rod (146) which is arranged on the tension and/or compression spring (100).

6. Apparatus for changing a leaf spring characteristic according to one of the preceding claims,
characterized in that
the tension and/or compression spring (100) has a spring rate from 30 to 80 N/mm.

7. Apparatus for changing a leaf spring characteristic according to one of the preceding claims,
characterized in that
the spiral spring (200) is made of a typical leaf spring material.

8. Apparatus for changing a leaf spring characteristic according to one of the preceding claims,
characterized in that
the attachment device (220) has a bracket (222) for encompassing at least one layer of the leaf spring (10) and the legs (224) of the bracket (222) each have an exterior thread (226), which in cooperation with through-holes disposed in another clamping plate (142) and nuts (312) realize a movable mechanical attachment which has an adjustable spacing (212) between the leaf spring (10) and the spiral spring (200).

9. Spring assembly, comprising at least one the spring and an apparatus according to the invention attached to the leaf spring for changing a leaf spring characteristic according to at least one of the claims 1 to 8, wherein the spiral spring (200), in addition to the attachment with the mounting device (130) associated with the tension and/or compression spring (100) and the attachment device (220) associated with the spiral spring (200), is with at least one surface that extends essentially perpendicular to the bending plane in contact with and attached over an area to a partial region of the main leaf (18) of the leaf spring (10).

10. Spring assembly according to claim 9,
characterized in that
attachment in the contact region is realized with a clamping device for force-transmitting connection of the individual layers of the leaf spring (10).

11. Spring assembly according to at least one of the claim 9 or 10,
characterized in that
the contact region is located essentially at the center of the leaf spring (10), and the connection between the leaf spring (10) and the spiral spring (200) is realized with the attachment device (220), while the connection between the corresponding end regions (20, 22) of the leaf spring (10) and the tension and/or compression spring (100) is realized with the mounting device (130).

12. Spring assembly according to at least one of the claims 9 to 11,
characterized in that
the spacing (212) between the attachment device (220) on the spiral spring (200) and the mounting device (130) on the tension and/or compression spring (100) is at least five sixth of the length of the leaf spring (10).

13. Spring assembly according to at least one of the claims 9 to 13,
characterized in that
the mounting device (130) is mechanically connected to the leaf spring (10) by way of the clamping unit (140) according to claim 5, and the attachment device (220) is mechanically connected to the leaf spring (10) by way of the bracket (222) according to claim 8.

14. Motor vehicle, in particular a van or a bus, comprising at least one spring assembly according to at least one of the claims 9 to 13.
